(19) United States
(12) Patent Application Publication
(10) Pub. No.: US 2006/0013947 A1
(43) Pub. Date: Jan. 19, 2006

(54) Method for manufacturing wiring board

(76) Inventors: Satoru Akatsuka, Yamagata (JP); Tsutomu Abe, Yamagata (JP); Toshinari Nanba, Yamagata (JP); Naoya Sato, Yamagata (JP); Akihito Narita, Yamagata (JP)

Correspondence Address: HARNESS, DICKEY & PIERCE, P.L.C., P.O. BOX 828, BLOOMFIELD HILLS, MI, 48303, US

(21) Appl. No.: 11/178,200

(22) Filed: Jul. 8, 2005

(30) Foreign Application Priority Data
Jul. 13, 2004 (JP) 2004-206067
Jan. 31, 2005 (JP) 2005-023605

(51) Int. Cl. B05D 5/12

(52) U.S. Cl. 427/99.5

(57) ABSTRACT

A method for manufacturing a wiring board includes electroless plating wiring patterns provided on a base substrate and cleaning the base substrate. The step of cleaning the base substrate includes at least either using an alkaline solvent or using an acid solvent.

### RELATED APPLICATIONS

This application claims priority to Japanese Patent Application Nos. 2004-206067 filed Jul. 13, 2004 and 2005-023605 filed Jan. 31, 2005 which are expressly incorporated by reference herein in their entirety.

### BACKGROUND

1. Technical Field

The present invention relates to a method for manufacturing a wiring board.

2. Related Art

It is known that a plated layer is formed on a wiring pattern by electroless plating. In order to manufacture a highly reliable wiring board, it is desirable that a plating liquid and metal adhered to a base substrate by plating be removed after the step of plating. If the plating liquid were removed in a short period of time, a highly reliable wiring board could be manufactured efficiently.

The present invention is intended to provide a highly reliable wiring board efficiently.

### SUMMARY

A method for manufacturing a wiring board according to the present invention includes electroless plating a wiring pattern provided on a base substrate; and cleaning the base substrate; wherein the step of cleaning the base substrate includes at least either using an alkaline solvent or using an acid solvent. According to the invention, the base substrate is cleaned after the step of electroless plating the wiring pattern. The step of cleaning the base substrate includes at least either using an alkaline solvent or using an acid solvent. The base substrate can therefore be cleaned efficiently and effectively, and a highly reliable wiring board can be manufactured efficiently.

In the method for manufacturing a wiring board, the step of electroless plating may be performed by using a plating liquid including at least either thiourea or its derivative; the step of cleaning the base substrate may include the step of using an alkaline solvent; and a solvent containing amine may be used as the alkaline solvent. Thus the plating liquid can be efficiently removed from the base substrate, and a highly reliable wiring board can be efficiently manufactured.

In the method for manufacturing a wiring board, metal adhered to the base substrate during the step of electroless plating may be removed by the step of cleaning the base substrate. Thus a highly reliable wiring board can be manufactured.

The method for manufacturing a wiring board may further comprise forming a resist layer on the base substrate after the step of cleaning the base substrate.

In the method for manufacturing a wiring board, the wiring pattern may be adhered to the base substrate with an adhesive interposed therebetween.

### BRIEF DESCRIPTION OF THE DRAWINGS

FIG. 1 is a view for illustrating a method for manufacturing a wiring board according to one embodiment to which the present invention is applied.

FIG. 2 is a view for illustrating a method for manufacturing a wiring board according to one embodiment to which the invention is applied.

FIGS. 3A and 3B are views for illustrating a method for manufacturing a wiring board according to one embodiment to which the invention is applied.

FIG. 4 is a view for illustrating a method for manufacturing a wiring board according to one embodiment to which the invention is applied.

FIG. 5 is a view for illustrating a method for manufacturing a wiring board according to one embodiment to which the invention is applied.

FIG. 6 is a view for illustrating a method for manufacturing a wiring board according to one embodiment to which the invention is applied.

FIG. 7 is a view for illustrating a method for manufacturing a wiring board according to one embodiment to which the invention is applied.

FIG. 8 is a view showing an electronic module having a wiring board manufactured by a method according to one embodiment to which the invention is applied.

FIG. 9 is a view showing an electronic device having a wiring board manufactured by a method according to one embodiment to which the invention is applied.

FIG. 10 is a view showing an electronic device having a wiring board manufactured by a method according to one embodiment to which the invention is applied.

### DETAILED DESCRIPTION

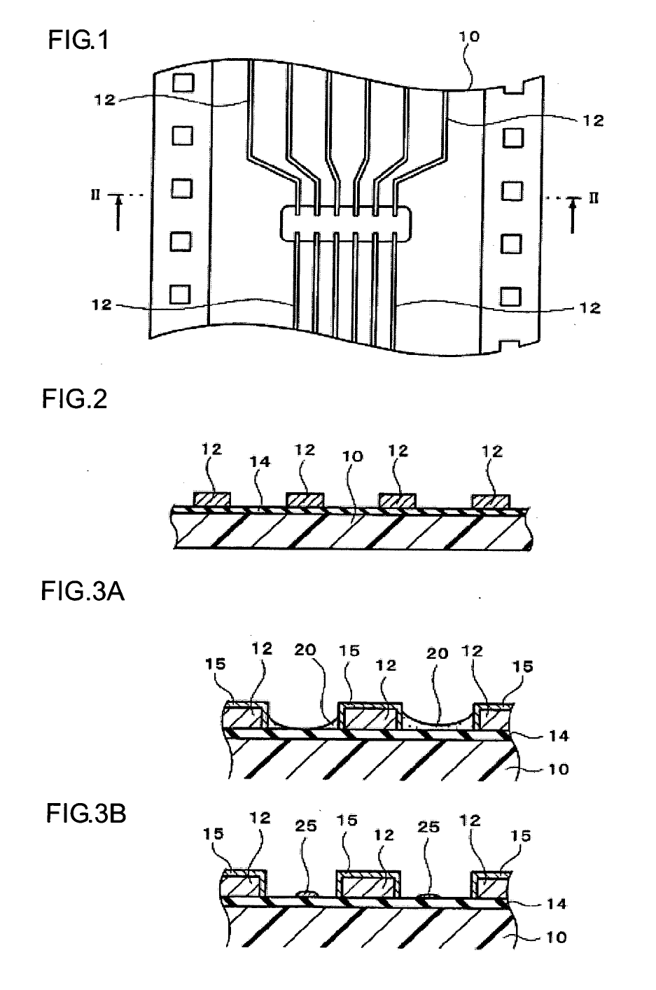

An embodiment to which the present invention is applied will now be described with reference to the accompanying drawings. The invention, however, is not restricted to the embodiment described below. FIGS. 1 to 7 are views for illustrating a method for manufacturing a wiring board according to one embodiment to which the invention is applied.

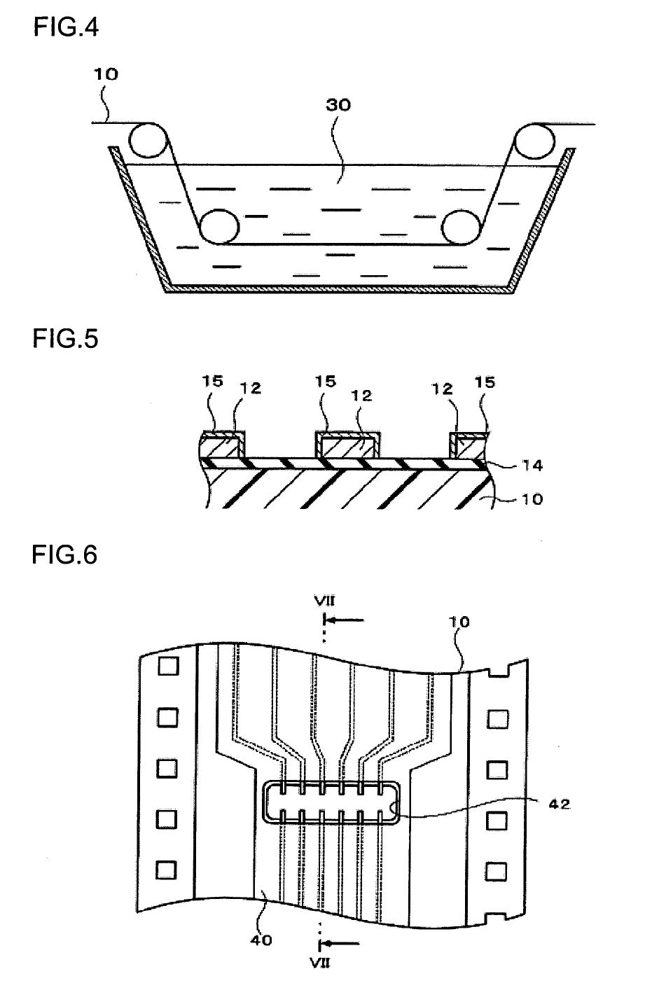

A method for manufacturing a wiring board according to the present embodiment may include preparing a base substrate 10 shown in FIGS. 1 and 2. FIG. 1 is a plan view of the base substrate 10, and FIG. 2 is a partially enlarged sectional view taken along the line II-II in FIG. 1. The material and the construction of the base substrate 10 are not particularly limited, and any one of substrates that are already known may be used as the base substrate 10. The base substrate 10 may be either a flexible substrate or a rigid substrate, or may be a tape substrate (refer to FIG. 1 or 4). The base substrate 10 may be either a stacked-typed substrate or a single-layer substrate. The outer shape of the base substrate 10 is also not particularly limited. The base substrate 10 comprises wiring patterns 12 as shown in FIG. 1. The wiring patterns 12 may be provided on the surface of the base substrate 10. The material and the construction of the wiring patterns 12 are not particularly limited, and may use those of any one of wirings that are already known. For example, the wiring patterns 12 may be formed by stacking any one of copper (Cu), chromium (Cr), titanium (Ti), nickel (Ni), titanium-tungsten (Ti—W), gold (Au), aluminum (Al), nickel-vanadium (NiV), and tungsten (W) layers on top of another, or may be formed consisting of any one of these layers. The method for forming the wiring patterns 12 is not particularly limited, and the wiring patterns 12 may be formed by providing a conductive foil on the surface of the base substrate 10 and patterning it. The wiring patterns 12 may be adhered to the base substrate 10 with an adhesive 14 interposed therebetween as shown in FIG. 2. The material of the adhesive 14 is not particularly limited, and an epoxy adhesive may be used as the material. The wiring patterns 12 may also be adhered to the base substrate 10 without using an adhesive (not shown).

The method for manufacturing a wiring board according to the embodiment includes electroless plating the wiring patterns 12. The electroless plating may be performed by using a plating liquid 20. In this electroless plating, any one of plating liquids that are already known may be used as the plating liquid 20. The plating liquid 20 may be one containing at least either thiourea or its derivative. In other words, the electroless plating may be performed by using a plating liquid that contains at least either thiourea or its derivative. By the electroless plating, plated layers 15 are formed on the wiring patterns 12 as shown in FIG. 3A. Performing plating makes it possible to form a highly reliable wiring board that is easy to electrically connect with an electronic component such as a semiconductor chip. The electroless plating may include immersing the base substrate 10 (the wiring patterns 12) into the plating liquid 20. The plating liquid 20 may be a tin plating liquid. Namely, the plating liquid 20 may be a solution containing tin ions. In this situation, the wiring patterns 12 may be copper wirings. The surfaces of the wiring patterns 12 may be replaced with tin to form the plated layers 15. In this case, the plated layers 15 may be formed of an Sn—Cu alloy. Immediately after this electroless plating, the residues of the plating liquid 20 usually exist on the base substrate 10 (on the adhesive 14) as shown in FIG. 3A. In particular, the plating liquid 20 sometimes remains between the wiring patterns 12. As shown in FIG. 3B, metal 25 that has been contained in the plating liquid 20 is sometimes adhered on the base substrate 10 (on the adhesive 14). In other words, the metal 25 shown in FIG. 3B is probably adhered to the base substrate 10 during the electroless plating. In order to prevent quality deterioration of a wiring board and occurrence of migration, it is preferable that the residues of the plating liquid 20 be removed from the base substrate 10. It is also preferable that the metal 25 be removed from base substrate 10. Therefore, in the method for manufacturing a wiring board according to the embodiment, the step of cleaning the base substrate 10 is performed after the plating step. By using this, the residues of the plating liquid 20 may be removed from the base substrate 10 (the adhesive 14), or the metal 25 may be removed from the base substrate 10 (the adhesive 14).

The method for manufacturing a wiring board according to the embodiment includes cleaning the base substrate 10. The step of cleaning the base substrate 10 includes at least either using an alkaline solvent or using an acid solvent. In detail, the method for manufacturing a wiring board according to the embodiment may clean the base substrate 10 by just the operation of using an alkaline solvent. The method for manufacturing a wiring board according to the embodiment may also clean the base substrate 10 by just the operation of using an acid solvent. Moreover, the method for manufacturing a wiring board according to the embodiment may clean the base substrate 10 by the operation of using an alkaline solvent and the operation of using an acid solvent. In the case of cleaning the base substrate 10 by these two operations, after being cleaned by using an alkaline solvent, the base substrate 10 may be cleaned by using an acid solvent. After being cleaned by using an acid solvent, the base substrate 10 may also be cleaned by using an alkaline solvent. In these cases, the latter cleaning may remove the solvent of the preceding cleaning from the base substrate 10. The latter cleaning may also be performed so that its solvent neutralizes the solvent of the preceding cleaning. By this step, the residues of the plating liquid 20 may be removed and the metal 25 may be removed from the base substrate 10 (the surface of the adhesive 14) and the surfaces of the wiring patterns 12 (the plated layers 15) (refer to FIG. 5). This step may, for example, include immersing the base substrate 10 into a solvent 30 by reel-to-reel conveying operations as shown in FIG. 4. This step may consist of either shower cleaning or shower cleaning with immersing. This step may perform cleaning while heating the solvent 30 (or the base substrate 10 and wiring patterns 12) to 30° C. or more, preferably in the range 50 to 70° C., and agitating it. Thus the cleaning step can be performed efficiently. Any one of solvents that are already known may be used as the alkaline solvent and the acid solvent. A sodium hydroxide solution, for example, may be used as the alkaline solvent. Sulfuric acid or hydrochloric acid may be used as the acid solvent. The step of cleaning may further include removing the solvent 30 from the base substrate 10.

In the method for manufacturing a wiring board according to the embodiment, as described above, the plating liquid 20 may include at least either thiourea or its derivative, wherein the step of cleaning the base substrate 10 may include the operation of using an alkaline solvent. In this case, a solvent containing amine may be used as the alkaline solvent. If the plating liquid 20 contains at least either thiourea or its derivative, a thiourea complex formed from thiourea or its derivative exists in the plating liquid 20 that remains on the base substrate 10 after plating. For example, if the surfaces of the wiring patterns 12 are copper, copper and a thiourea complex exist in the plating liquid 20. Accordingly, if a solvent (a polar solvent) with a polarity dose to that of the thiourea complex is used, the thiourea complex can readily be dissolved into the solvent, whereby the plating liquid 20 can be efficiently removed from the base substrate 10 (the adhesive 14). Namely, by using the solvent 30 that contains amine and has a polarity dose to that of the thiourea complex, the plating liquid 20 can be removed efficiently. Particularly when the wiring patterns 12 are adhered with the adhesive 14, the thiourea complex is in some cases ionized and drawn to the surface of the adhesive 14, thereby making it difficult to remove the plating liquid 20. In such cases, however, by using the solvent 30 containing amine, the plating liquid 20 can readily be removed and, as a result, a wiring board can be manufactured efficiently. Incidentally, the amine contained in the solvent 30 may be any one or more of, for example, ethanolamine, propanolamine, butanolamine, N (β-aminoethyl) ethanolamine, diethanolamine, dipropanolamine, N-methylethanolamine, isopropanolamine, and N-ethylethanolamine. The solvent 30 may also contain the above amines and glycol ethers such as ethylene glycol monohexyl ether, ethylene glycol phenyl ether, diethylene glycol monomethyl ether, triethylene glycol monomethyl ether, and dipropylene glycol monomethyl ether. In this case, mixing amines contained in the solvent 30 at the concentration in the 20 to 50% range can further enhance cleaning effect. The solvent 30 can further contain a surface-active agent. Thus the plating liquid 20 can be further efficiently removed.

Additionally, the step of cleaning the base substrate 10 may be performed by using, together with or instead of the above action, the action that the solvent 30 removes (chemical etching) part of the surface of the base substrate 10 (the adhesive 14). Namely, the plating liquid 20 or the metal 25 may be removed by removing part of the surface of the base substrate 10 with the solvent 30 (e.g. alkaline solvent). The step of cleaning the base substrate 10 may clean the base substrate 10 by using the property of the solvent 30 that melts metal. Namely, the metal 25 may be removed from the base substrate 10 by melting the metal 25 with the solvent 30 (e.g. alkaline solvent). The cleaning step described above is preferably performed without damaging the base substrate 10 and the wiring patterns 12 (the plated layers 15). In order not to damage the base substrate 10 and the wiring patterns 12 (the plated layers 15), the cleaning step may be performed with the concentration of the solvent 30 and the cleaning time adjusted. The step of cleaning the base substrate 10 may additionally use the physical power that is produced when the solvent 30 flows on the base substrate 10.

The method for manufacturing a wiring board according to the embodiment may include heating the base substrate 10 (the plated layers 15). Thus occurrence of a whisker can be prevented and therefore a highly reliable wiring board can be manufactured.

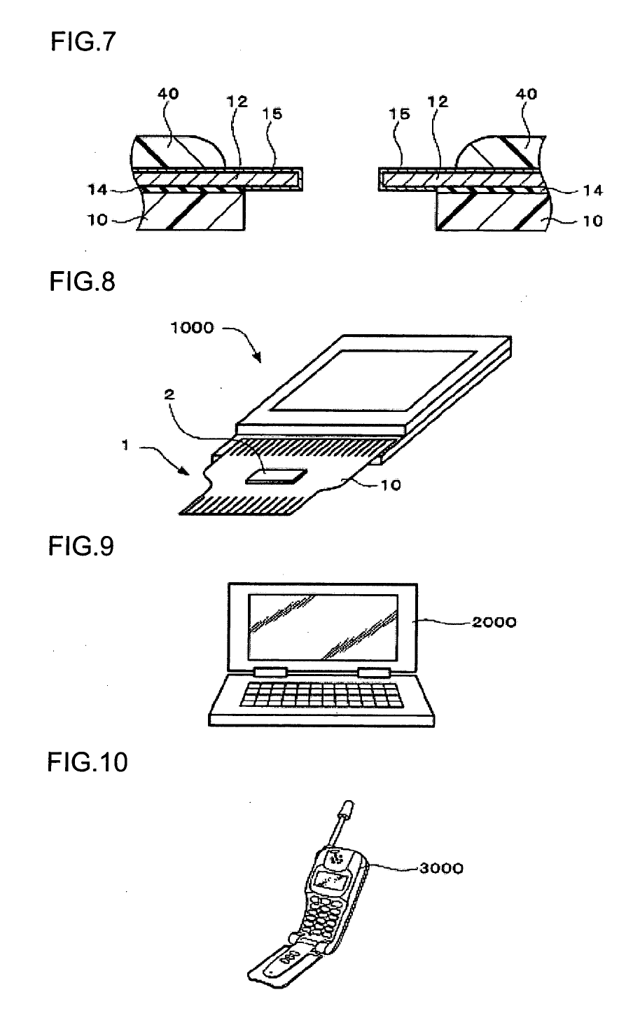

The method for manufacturing a wiring board according to the embodiment may include forming a resist layer 40 on the base substrate 10 as shown in FIGS. 6 and 7. The resist layer 40 may be formed to partially cover the plated layers 15 (the wiring patterns 12). FIG. 7 is a partially enlarged sectional view taken along the line VII-VII in FIG. 6. Corrosion and short circuits of the plated layers 15 (the wiring patterns 12) can be prevented by the resist layer 40 and therefore a highly reliable wiring board can be manufactured. The resist layer 40 may have an opening 42 as shown in FIG. 6. Portions of the plated layers 15 may be exposed from the opening 42 and used for electrically connecting with an electronic component such as a semiconductor chip. This resist layer formation may be performed after the above described cleaning step. Thus the plating liquid 20 can be prevented from remaining between the base substrate 10 and the resist layer 40, and therefore a highly reliable wiring board in which quality deterioration by the plating liquid 20 and migration are difficult to occur can be manufactured. A wiring board 1 may be manufactured through the operations of inspecting and cutting the base substrate 10 (refer to FIG. 8). However, the state with base substrate 10 being not cut may be referred to as a wiring board (refer to FIGS. 6 and 7).

FIG. 8 shows an electronic module 1000 having the wiring board 1 manufactured by a method according to one embodiment to which the invention is applied. In the electronic module 1000, a semiconductor chip 2 is mounted on the wiring board 1. The method for mounting the semiconductor chip 2 is not particularly restricted, and any one of mounting methods that are already known may be applied. The electronic module 1000 may be a display device. The display device may be, for example, a liquid crystal display device or an electrical luminescence display device. As electronic devices having the wiring board 1, a note type personal computer 2000 and a cellular phone 3000 are further shown in FIGS. 9 and 10, respectively.

The present invention is not restricted to the above described embodiment, and various modifications may be made. For example, the invention includes substantially the same structure as described in the embodiment (such as a structure having the same function, method, and result or a structure having the same object and effect). The invention also includes a structure in which nonessential part of the structure described in the embodiment is replaced. The invention also includes a structure having the same action and effect as those described in the embodiment or a structure by which the same object can be obtained. The invention also includes a structure having a known technique in addition to the structure described in the embodiment.

What is claimed is:

1. A method for manufacturing a wiring board, the method comprising:
electroless plating a wiring pattern provided on a base substrate; and
cleaning the base substrate;
wherein the step of cleaning the base substrate includes at least either using an alkaline solvent or using an acid solvent.

2. The method for manufacturing a wiring board according to claim 1, wherein:
the step of electroless plating is performed by using a plating liquid including at least either thiourea or a derivative of the thiourea;
the step of cleaning the base substrate includes the step of using an alkaline solvent; and
a solvent containing amine is used as the alkaline solvent.

3. The method for manufacturing a wiring board according to claim 1, wherein metal adhered to the base substrate during the step of electroless plating is removed by the step of cleaning the base substrate.

4. The method for manufacturing a wiring board according to claim 1, the method further comprising forming a resist layer on the base substrate after the step of cleaning the base substrate.

5. The method for manufacturing a wiring board according to claim 1, wherein the wiring pattern is adhered to the base substrate with an adhesive interposed therebetween.
